(19) United States
(12) Patent Application Publication
(10) Pub. No.: US 2026/0212310 A1
(43) Pub. Date: Jul. 23, 2026

(54) EFFICIENT AND ENHANCED MAP USER INTERFACE

(71) Applicant: DoorDash, Inc., San Francisco, CA (US)

(72) Inventors: Eric Pan, San Francisco, CA (US); Gayatri Iyengar, Cupertino, CA (US); Srinivasaraghavan Vedanarayanan, Sunnyvale, CA (US)

(73) Assignee: DoorDash, Inc., San Francisco, CA (US)

(21) Appl. No.: 19/027,778

(22) Filed: Jan. 17, 2025

(51) Int. Cl. G06Q 10/0833; G06Q 10/0835

(52) U.S. Cl. CPC G06Q 10/0833; G06Q 10/08355

(57) ABSTRACT

A method includes a server computer receiving location data and time data associated with a transporter user device of a transporter that travels from a first location to a second location during a journey to deliver an item from the first location to the second location. The server computer receives supplemental information during the journey from the transporter user device. The server computer determines a location datum and a time datum associated with the supplemental information. The server computer stores the supplemental information, the location datum, and the time datum in a database. The server computer receives, from a client device, a request to generate a map showing the journey and the supplemental information. The server computer provides, to the client device, data related to the map showing the journey and the supplemental information at a location associated with the location datum.

### CROSS-REFERENCES

The present application is related to U.S. Application No. ______ (Attorney Docket No. 107723-1463820), entitled “Use of Machine Vision and ML Model to Interpret Map Data,” which is filed on the same day as the present application and is herein incorporated by reference in its entirety.

### SUMMARY

One embodiment is related to a method comprising: receiving, by a server computer, location data and time data associated with a transporter user device of a transporter that travels from a first location to a second location during a journey to deliver an item from the first location to the second location; receiving, by the server computer from the transporter user device, supplemental information during the journey; determining, by the server computer, a location datum and a time datum associated with the supplemental information; storing, the supplemental information, the location datum, and the time datum in a database; receiving, by the server computer from a client device, a request to generate a map showing the journey and the supplemental information; and providing, by the server computer to the client device, data related to the map showing the journey and the supplemental information at a location associated with the location datum.

Another embodiment is related to a server computer comprising: a processor; and a computer-readable medium coupled to the processor, the computer-readable medium comprising code executable by the processor for implementing a method comprising: receiving, by a server computer, location data and time data associated with a transporter user device of a transporter that travels from a first location to a second location during a journey to deliver an item from the first location to the second location; receiving, by the server computer from the transporter user device, supplemental information during the journey; determining, by the server computer, a location datum and a time datum associated with the supplemental information; storing, the supplemental information, the location datum, and the time datum in a database; receiving, by the server computer from a client device, a request to generate a map showing the journey and the supplemental information; and providing, by the server computer to the client device, data related to the map showing the journey and the supplemental information at a location associated with the location datum.

Another embodiment is related to a method comprising: generating, by a client device, a map request message comprising a request to generate a map showing a journey and supplemental information; providing, by the client device, the map request message to a server computer, wherein the server computer generates a map based on data in a database; receiving, by the client device, data related to the map from the server computer; and displaying, by the client device, the map showing the journey and the supplemental information at a location associated with a location datum of the supplemental information.

Further details regarding embodiments of the disclosure can be found in the Detailed Description and the Figures.

### BRIEF DESCRIPTION OF THE DRAWINGS

FIG. 1 shows a block diagram of a map generation system according to embodiments.

FIG. 2 shows a block diagram of components of a central server computer according to embodiments.

FIG. 3 shows a diagram illustrating a map showing a journey according to embodiments.

FIG. 4 shows a diagram illustrating a map showing first supplemental information according to embodiments.

FIG. 5 shows a diagram illustrating a map showing second supplemental information according to embodiments.

FIG. 6 shows a flow diagram illustrating a map generation method according to embodiments.

### DETAILED DESCRIPTION

Prior to discussing embodiments of the disclosure, some terms can be described in further detail.

Prior to discussing embodiments of the disclosure, some terms can be described in further detail.

An “item” can be an individual article or unit. Examples of items can include perishable items such as food items, beauty items (e.g., cosmetics), office supply products (e.g., staples, paper, and ink), hardware items (e.g., nails, hammers, wrenches), electronic devices (e.g., computers, phones, etc.), jewelry, etc.

A “user” may include an individual or a computational device. In some embodiments, a user may be associated with one or more personal accounts and/or mobile devices. In some embodiments, the user may be a consumer or a customer.

A “user device” may be a device that is operated by a user. In some embodiments, the user device can be an electronic device that can process information and communicate with other electronic devices. A user device may include a processor and a computer-readable medium coupled to the processor, the computer-readable medium comprising code, executable by the processor. Examples of user devices may include a mobile device, a laptop or desktop computer, a wearable device, etc.

A “transporter” can be an entity that transports something. A transporter can be a person that transports an item using a transportation device (e.g., a car). In other embodiments, a transporter can be a transportation device that may or may not be operated by a human. Examples of transportation devices include cars, boats, scooters, bicycles, drones, airplanes, etc. In some embodiments, the transporter user device can be integrated into a transportation device.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a completed state, or a final state. A fulfillment request can include one or more selected items that a user wishes to obtain from a selected service provider.

A “delivery order” can include a request to deliver one or more items. Delivery orders can include requests to provide one or more items from a pickup location to a drop-off location. Delivery orders can include orders to deliver items from service provider locations to end user locations. Delivery orders can include orders to deliver items from end user locations to service provider locations. An example of this type of delivery order can be a return order (e.g., to deliver an item that is to be returned). A delivery order can include data to fulfill the delivery request including an order type, an indication of an item, a pickup location, and a drop-off location. In some embodiments, the delivery order can include a scheduling range by which the order is to be fulfilled. A delivery order can also include metadata. The metadata can include data relating to the delivery order (e.g., related order numbers, instruction data, etc.).

A “route” can include a way or course taken in getting from a starting point to a destination. For example, a route can indicate a path that can be followed to move from a pickup location to a drop-off location. In some embodiments, a route can indicate a suggested path that a transporter can follow to deliver an item from a service provider to an end user (or vice-versa) for a delivery order. In some embodiments, a route can be referred to as a journey.

“Location data” can include information that indicates a particular place or position. Location data can indicate a position in space. Location data can include a latitude and longitude position on Earth. In some embodiments, location data can include an altitude.

“Time data” can include information that indicates a particular point in time. Time data can include a time recorded with a UTC (coordinated universal time) time in GMT 0. Time data can include a time recorded in a local time in relation to a known location datum.

“Supplemental information” can include information in addition to what is already present or available to complete or enhance it. Supplemental information can include information in addition to location data and time data. Supplemental information can include an image, a video, a text conversation, an audio file, movement (e.g., speed, velocity, acceleration, etc.) evaluations, navigation events, user interface interaction actions, hotspots, and/or other data that can be displayed in a window displayed over a map.

For example, supplemental information can include an image of a delivered item at a drop-off location. As another example, supplemental information can include a video of a transporter approaching a location (e.g., a pickup location, a drop-off location, etc.). As another example, supplemental information can include a text conversation (e.g., an SMS conversation) between a transporter and an end user, where the text conversation includes messages sent during a delivery performed by the transporter. As another example, supplemental information can include an audio file that is recorded by a transporter during the delivery, where the audio file includes a recording of the transporter describing where they left the item that is delivered to an end user.

A “map” can include a diagrammatic representation of an area of land or sea showing physical features, cities, roads, and other information. A map can display visuals indicating location data and time data. A map can show a journey between two locations. For example, a map can show a journey of a transporter from a pickup location to a drop-off location to deliver an item to an end user. A map can show supplemental information. A map can be shown in a user interface on a display to a user. A map can be an interactive map that can allow a user to interact with elements on the map.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Map visualization can allow a user to see a map of an area. The map can indicate a path to follow to navigate between two locations. For example, a driver can request a map that indicates a path to drive from the driver's current location to a destination. The map can show the path and how long it might take to drive to the destination. Map visualization can also allow a user to view previous routes. The map can show a path that was taken to get to a destination.

Geospatial visualization of data has a high technical barrier to entry. A large volume of location data needed to create the geospatial visualizations. The large volume of location data is slow to query and load and is large in size when stored in a database. Further, gathering and including relevant data can be difficult. For example, some included data may have no location data and is thus difficult to place on a map.

In prior systems, if a user wanted to analyze the data for a particular journey for a particular purpose (e.g., determining if fraud is present), the user would need to obtain a map of a transporter's journey, and then separately look up any other data (e.g., text messages, photos, etc.) associated with that journey and analyze it. The user would need to piece together the data to understand the relationship between the map, and the various pieces of data. The user's retrieval and loading of such additional data consumes computing resources and takes time.

Embodiments of the disclosure address this problem and other problems individually and collectively.

Embodiments provide for systems and methods, which collectively can be referred to as “MapViz,” capable of visualizing journey-related data on a map interface displayed as a user interface to a user. Embodiments of the invention allow users to input a journey identifier, user identifier, or other journey identifying information, to view the corresponding journey details on a map. The map and user interface can display information related to the journey as well as supplemental information. The supplemental information can include images, videos, text conversations, etc.

Embodiments provide for improved user interfaces for computers. The improved user interfaces can allow users to more quickly access desired data stored in disparate locations in databases that may be unknown to the user. The improved user interfaces can optimally display map data as well as supplemental information that is associated with the map data. The user interface, provided by embodiments, improves usability, visualization, and efficiency.

In embodiments of the invention, a client device can request a map from a central server computer for a particular journey. The central server computer can generate the map displaying the journey and the supplemental information and provide the map to the client device. The client device can then allow a user of the client device to view the journey and the supplemental information. The map can be displayed via the user interface on the client device and can be interactive.

As an illustration, the map can show the journey and supplemental information such as images captured by a transporter along the journey. The images can be associated with locations at particular points in time along the journey. The map can display the images at the locations at which the images were captured within the user interface.

In some cases, the supplemental information may not be associated with a location on a map when created. The central server computer can determine a location for the supplemental information using other journey data.

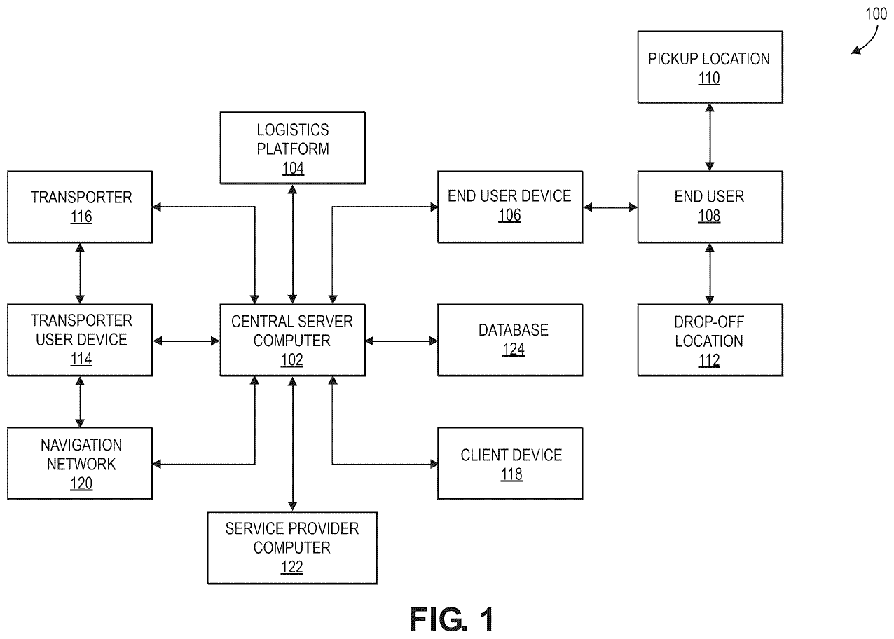

FIG. 1 shows a system 100 according to embodiments of the disclosure. The system of FIG. 1 includes a central server computer 102, a logistics platform 104, an end user device 106, an end user 108, a pickup location 110, a drop-off location 112, a transporter user device 114, a transporter 116, a client device 118, a navigation network 120, a service provider computer 122, and a database 124.

The central server computer 102 can be in operative communication with the logistics platform 104, the end user device 106, the transporter user device 114, the client device 118, the navigation network 120, the service provider computer 122, and the database 124. The transporter user device 114 can be in operative communication with the navigation network 120.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. For example, although FIG. 1 shows one transporter 116, there can be two, three, or more transporters, transporter user devices, etc.

Messages between the devices and the computers in the system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The central server computer 102 can include a server computer that can facilitate in the fulfillment of fulfillment requests received from the end user device 106. For example, the central server computer 102 can identify the transporter 116 (from among many candidate transporters) operating the transporter user device 114 as being suitable for satisfying the fulfillment request. The central server computer 102 can identify the transporter user device 114 that can satisfy the fulfillment request based on any suitable criteria (e.g., transporter location, service provider location, end user destination, end user location, transporter mode of transportation, etc.).

The central server computer 102 can receive data relating to a delivery order of items from the service provider computer 122 to the end user 108 at the drop-off location 112. The central server computer 102 can determine a route for delivery of the delivery order. The central server computer 102 can present the routes to a plurality of transporter user devices and/or transporters. The central server computer 102 can receive acceptances from the transporter 116 that will deliver the items from the pickup location 110 to the drop-off location 112.

The central server computer 102 can receive data from the transporter user device 114. The central server computer 102 can receive location data and time data associated with the transporter user device 114 of the transporter 116 that travels from a first location (e.g., the pickup location 110) to a second location (e.g., the drop-off location 112) during a journey. The central server computer 102 can also receive supplemental information during the journey (e.g., from the transporter user device 114, the transporter 116, the end user device 106, etc.). The central server computer 102 can determine a location datum and a time datum associated with the supplemental information. The central server computer 102 can store the supplemental information, the location datum, and the time datum in the database 124.

The central server computer 102 can receive a request to generate a map showing the journey and the supplemental information from a client device 118. The central server computer 102 can generate the map showing the journey and the supplemental information. The central server computer 102 can provide data related to the map showing the journey and the supplemental information at a location associated with the location datum.

The logistics platform 104 can include a location determination system, which can determine the locations of various user devices such as transporter user devices (e.g., the transporter user device 114) and end user devices (e.g., the end user device 106). The logistics platform 104 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 104 can be part of the central server computer 102 or can be a system that is separate from the central server computer 102.

The end user device 106 can include a device operated by the end user 108. The end user devices 106 can generate and provide fulfillment request messages to the central server computer 102. The fulfillment request message can indicate that the request (e.g., a request for a service) can be fulfilled by the service provider computer 122. For example, the fulfillment request message can be generated based on a cart selected at checkout during a transaction using a central server computer application installed on the end user device 106. The fulfillment request message can include one or more items from the selected cart.

The end user device 106 can provide a fulfillment request message to the central server computer 102 that indicates that the end user device 106 is requesting that the transporter 116 pick up an item from the pickup location 110 (e.g., end user's 108 location) and deliver the item to the drop-off location 112 (e.g., the service provider computer's 122 location).

The pickup location 110 can be a location in which items are stored. In the context of an outbound delivery from an end user at an end user location, examples of the pickup location 110 may be a house or an apartment, a mailbox, a service provider location (e.g., a retail store, a grocery store, a dry cleaning store), a pickup hub, etc. Items can first be obtained from a pickup location 110 and then be transported to the drop-off location 112. Examples of the drop-off location 112 can be similar to the pickup location 110, such as a house or apartment, a mailbox, a retail store, a grocery store, a dry cleaning store, a pickup hub, etc. In one example, the pickup location 110 can be a pizza parlor from which the end user 108 orders a pizza. The drop-off location 112 can be an apartment in which the end user 108 resides.

The transporter user device 114 can include a device operated by the transporter 116. The transporter user device 114 can include a smartphone, a wearable device, a personal assistant device, etc. The transporter 116 can accept an end user's fulfillment request via an acceptance message. For example, the transporter user device 114 can generate and transmit a request to fulfill a particular end user's fulfillment request to the central server computer 102. The central server computer 102 can notify the transporter user device 114 of the fulfillment request. The transporter user device 114 can respond to the central server computer 102 with a request to perform the delivery to the end user as indicated by the fulfillment request.

In some embodiments, the transporter 116 can be an operator of a vehicle. In other embodiments, the transporter 116 can be a vehicle that can be operated by an operator or can be autonomous. The vehicle can include a car, a truck, a van, a motorcycle, a bicycle, a drone, or other vehicle. If the vehicle is autonomous, it can be routed automatically by the central server computer 102 according to one or more determined routes.

In some embodiments, the client device 118 can be operated by a user that requests information from the central server computer 102 related to a journey. In some embodiments, the client device 118 can be the transporter user device 114. In other embodiments, the client device 118 can be the end user device 106. The client device 118 can provide a request to generate a map showing the journey and the supplemental information to the central server computer 102. The client device 118 can receive the requested map showing the journey and the supplemental information from the central server computer 102. The client device 118 can then display the map in a user interface showing the journey and the supplemental information.

The client device 118 can display the map in a user interface to the user of the client device 118. The client device 118 can comprise a display screen and can be configured to display the user interface showing the map on the display screen.

The navigation network 120 can provide navigational directions to the transporter user device 114. For example, the transporter user device 114 can obtain a location from the central server computer 102. The location can be a service provider parking location, a service provider location, an end user parking location, an end user location, etc. The navigation network 120 can provide navigational data to the location to the transporter user device 114. For example, the navigation network 120 can include a global positioning system that provides location data to the transporter user device 114.

The service provider computer 122 can be operated by a service provider. For example, the service provider computer 122 can be operated by a service provider such as a restaurant. The service provider can provide services to the end user 108 of the end user device 106. In embodiments of the invention, the service provider computer 122 can receive requests to prepare one or more items for delivery from the central server computer 102. The service provider computer 122 can initiate the preparation of the one or more items that are to be delivered to the end user 108 of the end user device 106 by the transporter 116 associated with the transporter user device 114.

The database 124 can include any suitable database. The database may be a conventional, fault tolerant, relational, scalable, secure database such as those commercially available from Oracle™ or Sybase™. The database 124 can store supplemental information (e.g., an image, a text message, etc.), the location datum (e.g., a location that includes a latitude and longitude, etc.), and the time datum (e.g., a specific time).

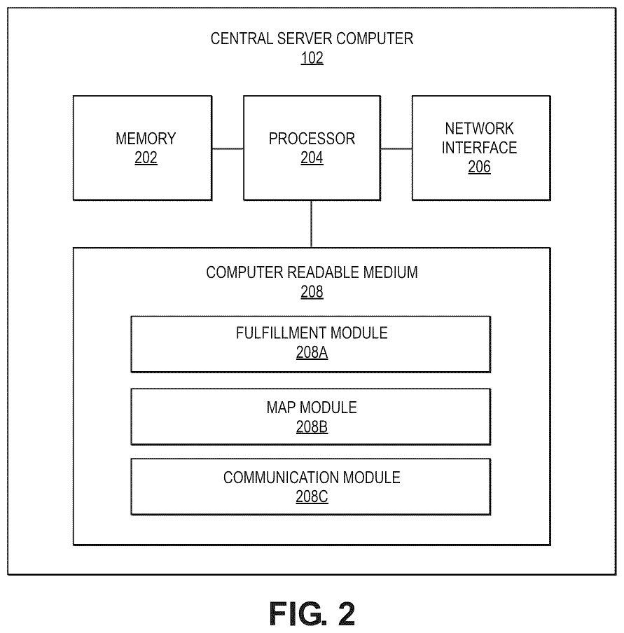

FIG. 2 shows a block diagram of an exemplary central server computer 102 according to embodiments. The central server computer 102 may comprise a processor 204. The processor 204 may be coupled to a memory 202, a network interface 206, and a computer readable medium 208. The computer readable medium 208 can comprise a fulfillment module 208A, a map module 208B, and a communication module 208C.

The memory 202 can be used to store data and code. For example, the memory 202 can store map data, location data, time data, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving location data and time data associated with a transporter user device of a transporter that travels from a first location to a second location during a journey to deliver an item from the first location to the second location; receiving, from the transporter user device, supplemental information during the journey; determining a location datum and a time datum associated with the supplemental information; storing the supplemental information, the location datum, and the time datum in a database; receiving, from a client device, a request to generate a map showing the journey and the supplemental information; and providing, to the client device, data related to the map showing the journey and the supplemental information at a location associated with the location datum.

The fulfillment module 208A may comprise code or software, executable by the processor 204, for facilitating fulfillment of fulfillment requests. The fulfillment module 208A, in conjunction with the processor 204, can receive a fulfillment request from an end user device 106. The fulfillment module 208A, in conjunction with the processor 204, can process the fulfillment request to determine a service provider computer associated with the fulfillment request. The fulfillment module 208A, in conjunction with the processor 204, can identify a transporter (from among many candidate transporters) operating the transporter user device 114 as being suitable for satisfying the fulfillment request. The central server computer 102 can identify the transporter user device 114 that can satisfy the fulfillment request based on any suitable criteria (e.g., transporter location, service provider location, end user destination, end user location, transporter mode of transportation, etc.). The fulfillment module 208A, in conjunction with the processor 204, can query the transporter for acceptance of the fulfillment request. The fulfillment module 208A, in conjunction with the processor 204, can provide update notifications to the transporter user device and the end user device relating to the progress of the journey.

The map module 208B may comprise code or software, executable by the processor 204, for generating, maintaining data for, and interacting with maps. The map module 208B, in conjunction with the processor 204, can receive a request to generate a map showing a journey and supplemental information from a client device. The request can include a journey identifier that identifies the journey. The map module 208B, in conjunction with the processor 204, can generate the map using location data, time data, and supplemental information obtained from a database using the journey identifier. The map module 208B, in conjunction with the processor 204, can determine location data for supplemental information that is not associated with location data using other location data that is near to the supplemental information in time. The map module 208B, in conjunction with the processor 204, can place the supplemental information on the map near to the location associated with the supplemental information. For example, the map module 208B, in conjunction with the processor 204, can place an image on the map at or near to a location at which the image was captured.

The communication module 208C may comprise code or software, executable by the processor 204, for communicating with other devices. The communication module 208C may be configured or programmed to perform some or all of the functionality associated with receiving, sending, and generating electronic messages for transmission through the central server computer 102 to or from any of the devices illustrated in FIG. 1. When an electronic message is received by the central server computer 102 via the network interface 206, the message can be passed to the communication module 208C. The communication module 208C, in conjunction with the processor 204, can identify and parse the relevant data based on a particular messaging protocol used in the central server computer 102. As an example, the received information may comprise identification information, authorization information, request information, response information, and/or any other information that the central server computer 102 may utilize in processing a message or a response. The communication module 208C, in conjunction with the processor 204, may then provide any received information to an appropriate module within the central server computer 102. The communication module 208C, in conjunction with the processor 204, may also receive information from one or more of the modules in the central server computer 102 and generate an electronic message in an appropriate data format in conformance with a transmission protocol used in another device so that the message may be sent to one or more devices within system 100. The electronic message can then be passed to the network interface 206 for transmission.

The network interface 206 may include an interface that can allow the central server computer 102 to communicate with external computers. The network interface 206 may enable the central server computer 102 to communicate data to and from another device (e.g., the logistics platform 104, the end user device 106, the transporter user device 114, the client device 118, the service provider computer 122, the database 124, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

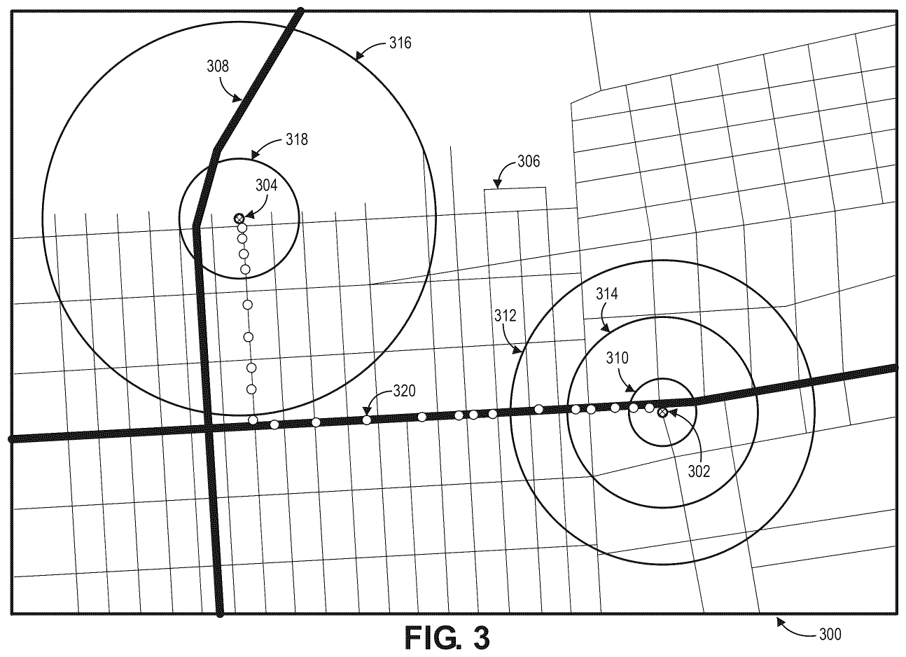

FIG. 3 shows a diagram illustrating a map 300 showing a journey according to embodiments. The diagram illustrated in FIG. 3 will be described in the context of a transporter (e.g., a person) that is operating a transporter user device (e.g., a mobile phone). In some cases, the transporter can be an autonomous vehicle and the transporter user device can be a component in the autonomous vehicle. The transporter picks up one or more items from a pickup location 302 to deliver to a drop-off location 304 for a journey that includes a delivery. The central server computer 102 can generate the map 300. The map 300 can be displayed to a user in a user interface. The user interface can allow the user to view the map 300 and interact with the map 300.

The map 300 includes the pickup location 302 and the drop-off location 304. The pickup location 302 and the drop-off location 304 can be identified by symbols on the map 300 (e.g., circles with filled with hatching). The pickup location 302 can be a merchant pickup location where the transporter can obtain the one or more items that are to be provided to the end user. The drop-off location 304 can be an end user drop-off location, such as a home address, a work address, or a current location of the end user.

The map 300 also includes a plurality of roads, which are indicated by lines. The map 300 includes symbols that indicate two categories of road. The map 300 includes small roads 306 and large roads 308 where the thickness of the line indicates that category of the road.

The map 300 includes concentric circles around the pickup location 302 and the drop-off location 304. The concentric circles can be geofences that indicate a boundary in the physical space represented by the map 300. The map 300 can include a first pickup location geofence 310, a second pickup location geofence 312, and a third pickup location geofence 314. The map 300 can also include a first drop-off location geofence 316 and a second drop-off location geofence 318. Each geofence can indicate boundary with a different meaning.

For example, the first pickup location geofence 310 be an approaching merchant geofence that indicates that the transporter is approaching the pickup location 302 of the merchant when proceeding to the pickup location 302. When the transporter crosses the boundary of the first pickup location geofence 310, the central server computer 102 can notify the transporter user device and the end user device that the transporter is near the merchant location.

The second pickup location geofence 312 can be a wide approaching merchant geofence that indicates that the transporter is generally approaching the pickup location 302 of the merchant when proceeding to the pickup location 302. The second pickup location geofence 312 can have a larger distance (e.g., radius) from the pickup location 302 than the first pickup location geofence 310. The second pickup location geofence 312 can provide for an initial indication that the transporter is approaching the pickup location 302.

The third pickup location geofence 314 can be a leaving merchant geofence that indicates that the transporter is leaving the pickup location 302 of the merchant after having been at the pickup location 302. When the transporter crosses the boundary of the third pickup location geofence 314, the central server computer 102 can notify the transporter user device and the end user device that the transporter is leaving the merchant location with the one or more items for delivery.

The first drop-off location geofence 316 can be a wide approaching the drop-off location geofence that indicates that the transporter is generally approaching the drop-off location 304. When the transporter crosses the boundary of the first drop-off location geofence 316, the central server computer 102 can notify the transporter user device and the end user device that the transporter is near the end user drop-off location.

The second drop-off location geofence 318 can be an approaching drop-off geofence that indicates that the transporter is approaching the drop-off location 304 of the merchant when proceeding to and near to the drop-off location 304. The second drop-off location geofence 318 can have a smaller distance (e.g., radius) from the drop-off location 304 than the first drop-off location geofence 316. The second drop-off location geofence 318 can provide for an fine grained indication that the transporter is near to the drop-off location 304.

The map 300 also includes a plurality of location data, which are indicated by circles. The plurality of location data can include an exemplary location datum 320. Each location datum of the plurality of location data can indicate a point in space at which the position of the transporter and/or the transporter user device was recorded and provided to the central server computer. Each location datum can correspond to a time datum that indicates a point in time at which the location datum was recorded. The plurality of location data can indicate a path on the map 300 that the transporter proceeded along to complete the journey.

For example, to obtain the location datum, coordinates and an atomic time can be obtained by a terrestrial global positioning system (GPS) receiver in the transporter user device from GPS satellites orbiting the Earth. The GPS receiver can collect data from at least four GPS satellites orbiting the Earth in order to calculate a position in three dimensions. The GPS coordinates can be exact points of latitudinal and longitudinal direction determined from GPS satellites.

In some embodiments, when the transporter and/or the transporter user device records the location datum, additional data can be recorded (e.g., speed, time, mode of transportation, traffic conditions, status updates, etc.). The plurality of location data, when displayed on the map 300, can be modified with the additional data. For example, the location datum 320 can be colored based on the speed of the transporter. As another example, the location datum 320 can be drawn on the map 300 with a different shape depending on the mode of transportation of the transporter (e.g., circle for cars, square for drones, etc.).

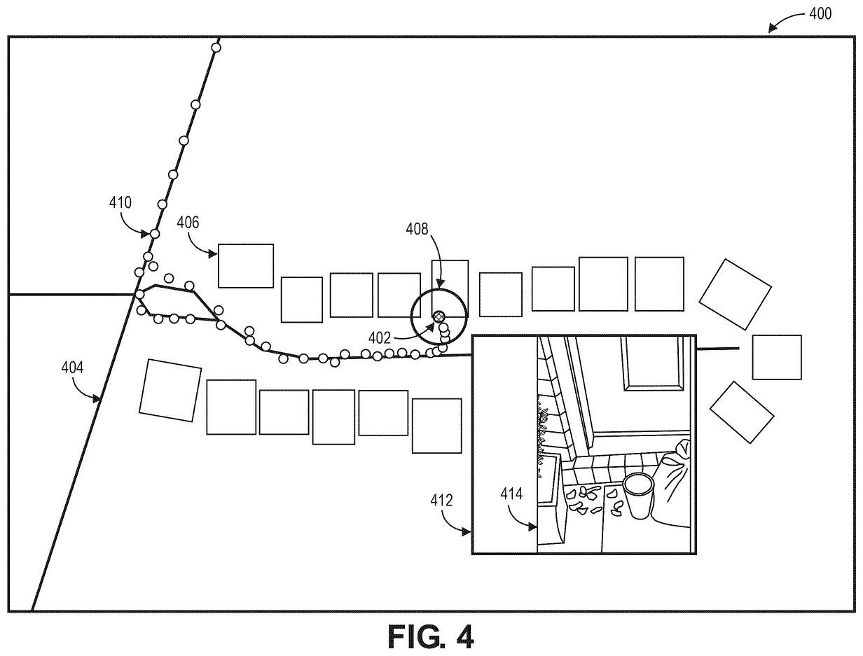

FIG. 4 shows a diagram illustrating a map 400 showing first supplemental information according to embodiments. The diagram illustrated in FIG. 4 can be described in the context of a transporter that is a person that operates a vehicle (e.g., a car) and a transporter user device (e.g., a smartphone). In can also apply to the case where the transporter is an autonomous vehicle. The transporter picks up one or more items from a pickup location (not shown) to deliver to a drop-off location 402 for a journey that includes a delivery. The central server computer 102 can generate the map 400. The map 400 can be displayed to a user in a user interface. The user interface can allow the user to view the map 400 and interact with the map 400.

The map 400 includes the drop-off location 402. The drop-off location 402 can be identified by symbol on the map 400 (e.g., circles with hatches). The drop-off location 402 can be an end user drop-off location, such as a home address of the end user.

The map 400 also includes a plurality of roads, which are indicated by lines. As an example, the map 400 includes the road 404. The map 400 includes a plurality of structures including the structure 406. The structures can be indicated by rectangles on the map 400 and can be buildings. As an example, the structure 406 can be a house.

The map 400 includes a drop-off location geofence 408 around the drop-off location 402. The drop-off location geofence 408 can be a geofence that indicates a boundary in a physical space represented by the map 400. The drop-off location geofence 408 can be an approaching end user drop-off location geofence that indicates that the transporter is approaching the drop-off location 402 of the end user when proceeding to the drop-off location 402. When the transporter crosses the boundary of the drop-off location geofence 408, the central server computer 102 can notify the transporter user device and/or the end user device that the transporter is nearing the merchant location.

The map 400 also includes a plurality of location data, which are indicated by circles. The plurality of location data can include an exemplary location datum 410. Each location datum of the plurality of location data can indicate a point in space at which the position of the transporter and/or the transporter user device was recorded and provided to the central server computer. Each location datum can correspond to a time datum that indicates a point in time at which the location datum was recorded. The plurality of location data can indicate a path on the map 400 that the transporter proceeded along to complete the journey as well as the path before and after the journey.

The map 400 includes supplemental information 412. The supplemental information 412 includes an image 414. The supplemental information 412 can be created by the transporter user device. For example, when the transporter is delivering the items to the end user at the drop-off location 402, the transporter user device can capture the image 414 of the items at the drop-off location 402.

As an illustrative example, when the transporter user device crosses the drop-off location geofence 408, the central server computer can notify the transporter user device of the proximity of the drop-off location 402. The central server computer can also prompt the end user device to capture the image 414 of the items when the items are delivered to the drop-off location 402. The end user device can transmit the supplemental information 412 including the image 414 to the central server computer.

The map 400 can display the image 414 as an overlay on the map 400 in the user interface. The image 414 can pop-up (e.g., be displayed in the user interface) when a user interacting with the map 400 hovers over a location associated with the image 414 (e.g., the drop-off location 402). In some cases, the image 414 can always be displayed on the map 400 proximate to the drop-off location 402, but offset vertically and/or horizontally such that nearby location datum of the journey can also be visible on the map 400.

The user interface can allow the user to dynamically visualize the journey portrayed on the map 400 as well as gain quick access to supplemental information without needing to open other programs or windows to search for relevant text conversations, images, etc. The user interface provides the user with the ability to view supplemental information (text conversations, images, etc.) in the same place as the map, making the supplemental information more easily accessible rather than requiring the user to search through text threads or photo libraries for relevant supplemental information.

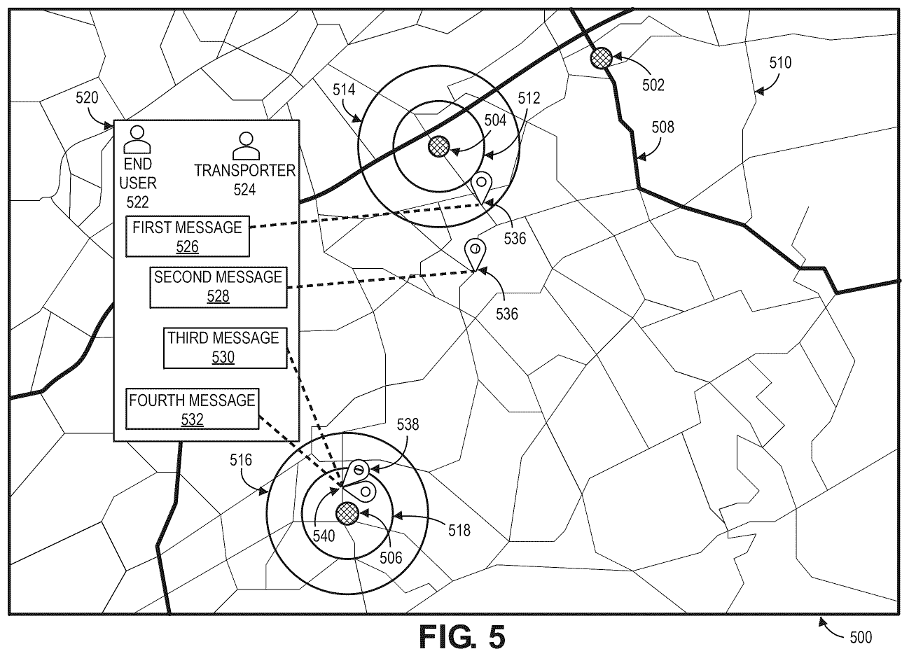

FIG. 5 shows a diagram illustrating a map 500 showing second supplemental information according to embodiments. The diagram illustrated in FIG. 5 will be described in the context of a transporter that is person that operates a vehicle and operates a transporter user device. The central server computer 102 can generate the map 500.

The map 400 includes a starting location 502, a pickup location 504, and a drop-off location 506. The starting location 502, the pickup location 504, and the drop-off location 506 can be identified by symbols on the map 400 (e.g., circles with hatching). The starting location 502 can be a location at which the transporter requested to complete the delivery. The pickup location 504 can be a merchant pickup location where the transporter can obtain items that are to be provided to the end user. The drop-off location 506 can be an end user drop-off location, such as a home address, a work address, or a current location of the end user.

In some embodiments, the journey can include the transporter user device traveling from a first location to a second location to deliver items from a service provider at the first location to an end user at the second location. The first location can be a pickup location and the second location can be a drop-off location.

The map 500 also includes a plurality of roads, which are indicated by lines. The map 500 includes symbols that indicate two categories of road. The map 500 includes small roads 510 and large roads 508 where the thickness of the line indicates that category of the road.

The map 500 includes concentric circles around the pickup location 504 and the drop-off location 506. The concentric circles can be geofences that indicate a boundary in the physical space represented by the map 500. The map 500 can include a first pickup location geofence 512 and a second pickup location geofence 514. The map 500 can also include a first drop-off location geofence 516 and a second drop-off location geofence 518. Each geofence can indicate boundary with a different meaning.

For example, the first pickup location geofence 512 be an approaching merchant geofence that indicates that the transporter is approaching the pickup location 504 of the merchant when proceeding to the pickup location 504. When the transporter crosses the boundary of the first pickup location geofence 512, the central server computer 102 can notify the transporter user device and the end user device that the transporter is nearing the merchant location.

The second pickup location geofence 514 can be a leaving merchant geofence that indicates that the transporter is leaving the pickup location 504 of the merchant after having been at the pickup location 504. When the transporter crosses the boundary of the second pickup location geofence 514, the central server computer 102 can notify the transporter user device and the end user device that the transporter is leaving the merchant location with the items for delivery.

The first drop-off location geofence 516 can be a wide approaching the drop-off location geofence that indicates that the transporter is generally approaching the drop-off location 506. When the transporter crosses the boundary of the first drop-off location geofence 516, the central server computer 102 can notify the transporter user device and the end user device that the transporter is near the end user drop-off location.

The second drop-off location geofence 518 can be an approaching merchant geofence that indicates that the transporter is approaching the drop-off location 506 of the merchant when proceeding to and near to the drop-off location 506. The second drop-off location geofence 518 can have a smaller distance (e.g., radius) from the drop-off location 506 than the first drop-off location geofence 516. The second drop-off location geofence 518 can provide for an fine grained indication that the transporter is near to the drop-off location 506.

The map 500 can also include supplemental information including a chat message window 520, which includes chat messages (e.g., a text conversation) between the end user 522 and the transporter 524. The chat messages can include a first message 526, a second message 528, a third message 530, and a fourth message 532. The supplemental information can also include location pins on the map 500, where each location pin corresponds to a message in the chat messages. The location pins include a first location 534, a second location 536, a third location 538, and a fourth location 540.

The first message 526 can be a message sent from the end user 522 to the transporter 524 at a time. The central server computer 102 can determine a location of the transporter 524 when the first message 526 was sent. The first location 534 can be the location of the transporter 524 when the first message 526 was received from the end user 522. The first message 526 can include, for example, delivery instructions. The first message 526 can include “Deliver the items to the side door.”

At a point later in time, the transporter 524 responded to the end user 522. The second message 528 can be a message created by the transporter 524 and provided to the end user 522. The second message 528 was sent when the transporter 524 was at the second location 536 during the journey to the drop-off location 506. The second message 528 can include the transporter's 524 confirmation of the first message 526. For example, the second message 528 can include “Noted, I will deliver the items to the side door.”

Further along the journey, the transporter 524 can provide a third message 530 to the end user 522. The third message 530 can be a message created by the transporter 524 at the third location 538. The third message can include “I am at a gate to the neighborhood, what is the code to enter?”

The end user 522 can respond to the third message 530 with the fourth message 532. The fourth message 532 can be a message created by the end user 522 and provided to the transporter 524 when the transporter 524 is at the fourth location 540. In this example, the third location 538 and the fourth location 540 can be proximate to one another since the transporter 524 is at a locked gate and awaiting entry. The fourth message 532 can include “the code is 1234.”

In some embodiments, the chat message window 520 can be displayed as an overlay over the map in the user interface. The chat message window 520 can be an interactable window and may be moved around the user interface. The chat message window 520 can include lines that indicate the relationship between the messages and locations on the map to indicate the location of the transporter 524 at the time of creation for each message. The supplemental information of the chat message window 520 can be displayed at a location on the map that does not obscure the location data.

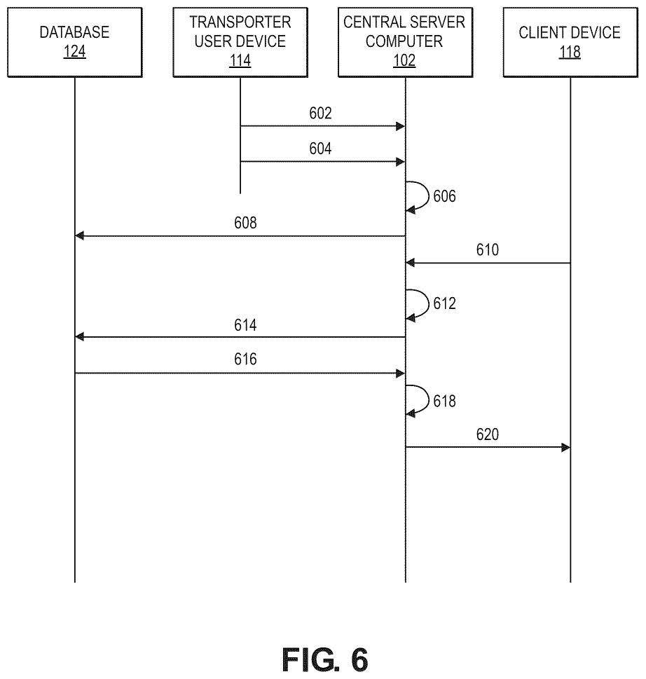

FIG. 6 shows a flow diagram illustrating a map generation method according to embodiments. The method illustrated in FIG. 6 will be described in the context of the transporter user device 114 providing data, during a delivery, to the central server computer 102. The central server computer 102 can process and store the received data. At a later point in time, the client device 118 can request a map that includes data related to the delivery associated with the transporter user device 114. The central server computer 102 can generate a map and provide the map to the client device 118.

At step 602, during a delivery journey, the transporter user device 114 can record location data and time data. The location data and the time data can be associated with the transporter user device 114. The location data can be a current location of the transporter user device 114. For example, the location data can be a location as indicated by a latitude and a longitude. In some embodiments, the location data can include an altitude. The time data can be a current time at which the location data is recorded.

The transporter user device 114 can provide the location data and the time data to the central server computer 102. In some embodiments, the transporter user device 114 can provide the location data and the time data in a delivery update message to the central server computer 102. For example, the transporter user device 114 can generate a delivery update message comprising the location data and the time data. The delivery update message can also comprise a transporter user device identifier and a delivery identifier that identifies the current delivery.

At step 604, during the journey, the transporter user device 114 can provide supplemental information to the central server computer 102. The transporter user device 114 can generate a supplemental information message comprising the supplemental information. The transporter user device 114 can provide the supplemental information message to the central server computer 102.

The supplemental information can include an image, a video, a text conversation, an end user review, a transporter review, delivery details (e.g., items delivered, a length of time taken, involved parties, etc.). The supplemental information can include data that indicates additional information related to the delivery.

As an example, in some embodiments, the supplemental information can include videos recorded by the transporter user device 114 or transporter vehicle at specific intervals during the journey. Each video can be displayed on the map in the user interface near to the location at which the video was captured. The map can indicate the path along which each video was recorded rather than a single point. For example, the transporter vehicle can be an autonomous car that records video while driving.

As another example, supplemental information can include movement evaluations. The movement evaluations can include speed, velocity, acceleration, and/or other movement related data. The movement evaluations can include measured movement data that indicates how the transporter user device was moving. The movement evaluations can include movement values that occur over a threshold movement value. For example, the movement evaluations can include speed data at locations at which the transporter's speed is over 100 mile per hour. As another example, the movement evaluations can include the acceleration data at locations at which the transporter's acceleration is over a threshold of 8 m/s^{s}. These thresholds can indicate unsafe speeds or acceleration indicative of harsh breaking or crashes.

As another example, supplemental information can include navigation events. A navigation event can occur when navigational instructions are provided to the transporter. For example, a navigation event can instruct the transporter to “turn left in 100 feet.” The supplemental information can include navigation events over the course of the delivery. Including navigation events into the supplemental information can allow a user of the map to determine 1) where the transporter was when they were prompted with navigation instructions, 2) if the transporter followed the navigation prompts, or 3) if the prompts were given in a timely fashion.

As another example, supplemental information can include user interface interaction actions. A user interface interaction action can be recorded when the transporter interacts with the user interface of the transporter user device (e.g., presses a button on a touch screen). The user interface interaction actions can indicate locations and times at which the transporter interacted with the user interface. Including user interface interaction actions into the supplemental information can allow a user of the map to determine where the transporter was when they were interacting with a delivery application installed on the transporter user device as opposed to when the transporter was driving or performing other tasks. Including user interface interaction actions into the supplemental information can also allow a user of the map to determine what the transporter did in the delivery application in conjunction with other data, such as the movement evaluations (e.g., was the transporter speeding and interacting with the transporter user device at the same time?).

As another example, supplemental information can include hotspots. A hotspot can be a geographical area that indicates high demand for deliveries. The supplemental information can include hotspots that were present at certain times during the transporter's delivery. For example, a first hotspot and a second hotspot can be present and viewable by the transporter during the delivery. The supplemental information can include the first hotspot and the second hotspot. Including hotspot information into the supplemental information can aid users of the resulting map in determining what the hotspots looked like from the transporter's perspective during the delivery. For example, including hotspot information into the supplemental information can allow a user of the map to determine whether the transporter used the hotspot views and how the transporter reacted or interacted with the hotspots (e.g., moved towards the hotspots, stayed in the hotspots, changed between hotspots, etc.).

At step 606, after any suitable amount of time after receiving the supplemental information, the central server computer 102 can determine a location datum and a time datum associated with the supplemental information. The supplemental information may not be currently associated with a particular location datum or time datum that is received in delivery update messages from the transporter user device 114.

The central server computer 102 can determine a time datum based on a time associated with a timestamp of when the supplemental information message was provided from the transporter user device 114 to the central server computer 102. The time datum can indicate a time at which the supplemental information was provided to the central server computer 102. In some embodiments, central server computer 102 can assign a time at which the supplemental information was received as the time datum.

The central server computer 102 can determine a location datum for the supplemental information based on the time datum and other location data and time data received from the transporter user device 114. For example, the central server computer 102 can determine a location datum for the supplemental information using other location and time data stored in the database 124.

The central server computer 102 can identify a first location datum that is associated with a first time datum before the supplemental information time datum. The central server computer 102 can identify a second location datum that is associated with a second time datum after the supplemental information time datum. The central server computer 102 can interpolate between the first location datum and the second location datum to obtain a supplemental information location datum that occurs at a time of the supplemental information time datum. The central server computer 102 can linearly interpolate or can interpolate based on the velocity of the transporter user device 114 at the locations.

In some embodiments, the location datum and a time datum associated with the supplemental information can be obtained by the transporter user device 114 when obtaining the supplemental information. For example, the transporter user device 114 can store the location and the time at which an image is captured. The transporter user device 114 can provide a supplemental information message comprising the supplemental information and the location datum and the time data that are associated with the supplemental information to the central server computer 102.

At step 608, after determining the location datum and the time datum associated with the supplemental information, the central server computer 102 can store the supplemental information, the location datum, and the time datum in the database 124.

At step 610, at any point thereafter, the client device 118 can generate a map request message. The map request message can include a request to generate a map showing the journey and the supplemental information.

The map request message can also include journey identifying information. The journey identifying information can include data that identifies a specific journey. For example, the journey identifying information can include a transporter user device identifier, a journey identifier, a transporter identifier, a time range, an end user identifier, a location, and/or other data that can aid in identifying a particular journey.

The client device 118 can provide the map request message to the central server computer 102. The client device 118 can provide the map request message through an API or other suitable means of communication.

At step 612, after receiving the map request message from the client device 118, the central server computer 102 can determine which data to request from the database 124 for map generation based on the transporter user device identifier or the deliver identifier. The central server computer 102 can generate a data request message that requests the relevant data. In some embodiments, the data request message can be a SQL query. The central server computer 102 can provide the data request message to the database 124.

At step 614, the central server computer 102 can provide the data request message to the database 124.

At step 616, the database 124 can obtain the requested data and can provide the requested data to the central server computer 102. The requested data can include location data, time data, and supplemental data.

In some embodiments, the central server computer 102 can chain data requests to request data from the database 124. The central server computer 102 can fetch data with one identifier (e.g., a journey identifier), then get other identifiers and parameters from the response from the database 124 to fetch additional data, thus chaining data requests together. For example, the central server computer 102 can request data related to the journey using the journey identifier. The database 124 can return location data and time data of a transporter's movement as well as supplementary information identifiers to the central server computer 102. The central server computer 102 can then request the supplementary information identifiers to obtain the supplementary data itself. For example, the image data of the supplementary information may be stored separately in the database from the location data and the time data of the transporter's movement, but may still be associated with the journey.

As another example, the central server computer 102 can provide a journey identifier (e.g., a delivery ID) to obtain a dispatch delivery data object from the database 124. The central server computer 102 can then apply a predetermined function to the dispatch delivery data object to determine a start event “driver_confirmed” to get all of the transporter IDs involved in the delivery (e.g., if more than one transporter is involved with an order of two or more items). The central server computer 102 can then apply logic to find the end event and time, such as, “driver_unassigned” or “canceled” or “driver_dropped_off” to then fetch all the locations for each transporters'start and end time on the delivery. By chaining the data requests to the database 124, the central server computer 102 and the database 124 can obtain and aggregate wide ranging data by linking the data together with identifiers without needing to change or add new data models. For example, new supplementary data types (e.g., videos) can easily be introduced into the database 124 file structure by including a video identifier in an overall journey data object. This allows the journey data object to reference the video via an identifier, but does not need to be modified to stored videos.

At step 618, after receiving the requested data, the central server computer 102 can generate the map for the client device 118 using the requested data. The central server computer 102 can generate the map using data from the database 124. The central server computer 102 can obtain pre-generated satellite imagery and/or road network images. The pre-generated satellite imagery and/or road network images can be a background of what a user will see when looking at the map. Each location on the images of the pre-generated satellite imagery and/or road network images can correspond with a location (e.g., a GPS location).

The central server computer 102 can place the location data on the images of the pre-generated satellite imagery and/or road network images. For example, the location data can be the location of the transporter at specific times during the journey.

The central server computer 102 can also place other map elements on the map, such as geofences. For example, a geofence can be identified by a location at a radius (if the geofence is circular). The central server computer 102 can draw a perimeter of a circle on the map at the location of the geofence with the defined radius.

The central server computer 102 can place each element on the map using different colors, shapes, patterns, etc. to indicate further information related to the element. For example, the central server computer 102 can place transporter location data on the map using circles, where the color and/or size of the circle indicates the speed of the transporter. The central server computer 102 can draw the geofences on the map with different colors based on the meaning of the geofences.

The central server computer 102 can place the supplementary information on the map. The supplementary information can be displayed at location pins, lines, shapes, overlay windows, etc. on the map in the user interface. For example, if the supplementary information includes an image captured by the transporter at a particular location, the central server computer 102 can place the image on the map at the location. In some embodiments, the central server computer 102 can determine an offset value to offset the position of the image on the map as to not obscure other data placed on the map. For example, when placing the image, the central server computer 102 can iteratively move the image, perform collision detection with other data on the map, and iteratively move the image until no collision with other data on the map is determined. The central server computer 102 can draw a connection between the location on the map of the image and the image.

The image on the map can be interactive, and the supplemental information can be associated with the map, but not displayed to the user in the user interface until the user directly or indirectly requests it. When the map is later shown to a user, the user can hover over (e.g., via a mouse) the image to show details related to the image. When the user hovers over the image, a tooltip can allow the user to view the location of the image at a street view level. This can allow the user to confirm if the photo taken matches the location as viewed via street view images.

As an example, the supplemental information can include navigation events that include navigational instructions that were provided to the transporter during the journey at specific times. For example, a navigation event can instruct the transporter to “turn right in 500 feet.” The central server computer 102 can place the navigation events on the map. For example, the central server computer 102 can generate a navigation event image that is indicative of the navigation event instruction and place the navigation event image at a particular location (e.g., where the navigation event instruction was provided to the transporter) on the map.

In some embodiments, the central server computer 102 can enrich data obtained from the database 124. The central server computer 102 can evaluate fields of received data and use fields to generate new fields related to the journey. For example, transporter locations can have UTC time in GMT 0. However, the journeys occur in a time zone, usually not GMT 0. The central server computer 102 can obtain the service provider computer time zone and enrich the transporter location with a new field “timestamp_Local” so that users viewing the map can analyze locations and events from the same perspective of other tools and reports where the reports typically communicate in their local time zone. As another example, transporter locations can be associated with a speed in meters per second. When investigating how fast a transporter was moving in the interest of efficiency, insurance, crime, etc., using miles per hour or kilometers per hour can be more intuitive. The central server computer 102 can enrich the location data with computed fields for speed in miles per hour or kilometers per hour. Adding these computed fields to a received dataset can make the data more intuitive and easier to understand compared to the base raw data.

In some embodiments, the map can be created with different layers. Each layer can correspond to a different type of data. When a user views the map, the user may be provided the option to switch between different layers and can view one or more layers at a time. The different layers can include different formats that are optimized for different data types and visualizations. For example, the transporter location data can be utilized in a data point layer, which displays data points on the map, and an animated journey layer, which displays an animation of the movement of the transporter on the map. The different layer types allow for map users to answer different questions, allowing users to extract multiple insights from one dataset. The user interface can provide options to the user to select between layers.

In some embodiments, the central server computer 102 can determine the bounds of the map based on the location data. The central server computer 102 can center the map on a center of the journey and can zoom into the map such that the journey fills most of the map.

At step 620, after generating the map, the central server computer 102 can provide the map to the client device 118. In particular, the central server computer 102 can provide the data related to the map showing the journey and the supplemental information at a location associated with the location datum.

After receiving the map, the client device 118 can display the map to a user of the client device 118 in a user interface. The map can be displayed as illustrated and described in reference to FIGS. 3-5.

Embodiments of the disclosure have a number of advantages. Embodiments allow users to view maps that include not only journey location data, but also supplementary data. This is advantageous because a user can view supplementary data, such as an image of items at a drop-off location during a delivery, to verify whether or not the delivery was successful. For example, the user can compare the image taken by the transporter to a known image of the location. This can help prevent fraudulent deliveries, where a transporter claims to deliver an item, but delivers the item to a different location (such as a friend's house).

Embodiments also allow for users to perform visual investigation of what happened on a delivery, while not needing special skills or knowledge to create the map visualization or know how to navigate a database to obtain supplementary data. The user can access the map showing the location data and the supplementary data using only an ID of the delivery they want to evaluate. From the user's perspective, the information then populates on a map within seconds.

Embodiments provide for democratization of access to geospatial delivery investigation tools while simultaneously leveraging location data to improve customer support. By providing a user interface, integrating with internal data sources, and incorporating customer support functionalities, embodiments empower a wider range of users to conduct investigations and resolve delivery issues efficiently. Embodiments provide for system architecture and functionality that enable efficient and effective delivery investigations, reducing the time and effort required to resolve issues and enhance the overall delivery experience for transporters, end users, engineers, business operators, etc.

Embodiments of the invention are also more efficient than prior methods for analyzing data from the journeys of transporters. In prior systems, if a user wanted to analyze the data for a particular journey for a particular purpose (e.g., determining if fraud is present), the user would need to obtain a map of a transporter's journey, and then separately look up any other data (e.g., text messages, photos, etc.) associated with that journey and analyze it. The user would need to piece together the data to understand the relationship between the map, and the various pieces of data. The user's retrieval and loading of such additional data consumes computing resources and takes time. Embodiments of the invention improve the efficiency of such conventional methods by selectively associating supplemental information for a journey on a map displayable by a user interface on a user computer. The supplemental data on the map provides temporal and spatial context for the user so that the user (or a machine) can quickly understand what happened during the journey.

The maps according to embodiments of the invention could be used to train machine learning models as described in U.S. Application No. ______ (Attorney Docket No. 107723-1463820), which is filed on the same day as the present application and is herein incorporated by reference in its entirety.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

1. A method comprising:
receiving, by a server computer, location data and time data associated with a transporter user device of a transporter that travels from a first location to a second location during a journey to deliver an item from the first location to the second location;
receiving, by the server computer from the transporter user device, supplemental information during the journey, wherein the supplemental information is an image, a video, a text conversation, a movement evaluation, a navigation event, a user interface interaction action, or a hotspot;
determining, by the server computer, a location datum and a time datum associated with the supplemental information;
storing, by the server computer, the supplemental information, the location datum, and the time datum in a database;
receiving, by the server computer from a client device, a request to generate a map showing a path of the journey from the first location to the second location, the path formed from the location data and the time data, and the supplemental information; and
providing, by the server computer to the client device, data related to the map showing the path of the journey and the supplemental information at a location on the path corresponding to the location datum, wherein the client device is programmed to display the map showing the path of the journey and the supplemental information at the location on the path corresponding to the location datum.

2. The method of claim 1, wherein determining the location datum and the time datum associated with the supplemental information comprises:
determining, by the server computer the time datum based on a time of the transporter user device sending or the server computer receiving the supplemental information;
determining, by the server computer, a first time datum and associated first location datum in the database that occurs prior to the time datum;
determining, by the server computer, a second time datum and associated second location datum in the database that occurs after the time datum; and
interpolating, by the server computer, between the first location datum and the second location datum to determine the location datum.

3. The method of claim 1, wherein the supplemental information is received in a supplemental information message, and wherein the supplemental information message further comprises the location datum and the time datum.

4. The method of claim 1, wherein the location datum is a location at which the supplemental information was created, and wherein the time datum is a time at which the supplemental information was created.

5. The method of claim 1 further comprising:
generating, by the server computer, the map based on data in the database.

6. The method of claim 1, wherein the request to generate the map showing the journey and the supplemental information is received in a map request message, wherein the map request message comprises journey identifying information.

7. The method of claim 6, wherein the journey identifying information includes a transporter user device identifier, a journey identifier, a transporter identifier, a time range, an end user identifier, and/or a location.

8. The method of claim 6 further comprising:
determining, by the server computer, the journey based on the journey identifying information; and
obtaining, by the server computer, data associated with the journey from the database, wherein data for the journey includes location data, time data, and supplemental information.

9. (canceled)

10. The method of claim 1, wherein the journey includes the transporter user device traveling from the first location to the second location to deliver items from a service provider at the first location to an end user at the second location.

11. The method of claim 1, wherein the map shows one or more geofences associated with the journey.

12. (canceled)

13. A server computer comprising:
a processor; and
a computer-readable medium coupled to the processor, the computer-readable medium comprising code executable by the processor for implementing a method comprising:
receiving location data and time data associated with a transporter user device of a transporter that travels from a first location to a second location during a journey;
receiving, from the transporter user device, supplemental information during the journey, wherein the supplemental information is an image, a video, a text conversation, a movement evaluation, a navigation event, a user interface interaction action, or a hotspot;
determining a location datum and a time datum associated with the supplemental information;
storing, the supplemental information, the location datum, and the time datum in a database;
receiving, from a client device, a request to generate a map showing a path of the journey from the first location to the second location, the path formed from the location data and the time data, and the supplemental information; and
providing, to the client device, data representing the map showing path of the journey and the supplemental information at a location on the path corresponding to the location datum, wherein the client device is programmed to display the map showing the path of the journey and the supplemental information at the location on the path corresponding to the location datum.

14. The server computer of claim 13, wherein after receiving the request to generate the map, the method further comprises:
determining the journey;
obtaining data associated with the journey from the database, wherein data for the journey includes location data, time data, and supplemental information; and
generating the map using the data associated with the journey.

15. The server computer of claim 14, wherein the map displays a location of the transporter user device over time during the journey, a speed of the transporter user device at each location, and the supplemental information at a location on the map that does not obscure the location data.

16. The server computer of claim 13 further comprising:
a fulfillment module coupled to the processor;
a map module coupled to the processor; and
a communication module coupled to the processor.

17. The server computer of claim 13, wherein the client device is the transporter user device or an end user device, and wherein the server computer is a central server computer.

18. A method comprising:
generating, by a client device, a map request message comprising a request to generate a map showing a journey and supplemental information;
providing, by the client device, the map request message to a server computer,
wherein the server computer is programmed to
receive location data and time data associated with a transporter user device of a transporter that travels from a first location to a second location during the journey,
receive, from the transporter user device, supplemental information during the journey, wherein the supplemental information is an image, a video, a text conversation, a movement evaluation, a navigation event, a user interface interaction action, or a hotspot,
determine a location datum and a time datum associated with the supplemental information,
store the supplemental information, the location datum, and the time datum in a database,
receive, from the client device, the map request message, the map request message requesting the generation of a map showing a path of the journey from the first location to the second location, the path formed from the location data and the time data, and the supplemental information, and
provide, to the client device, data representing the map showing the path of the journey and the supplemental information at a location on the path corresponding to the location datum;
receiving, by the client device, data representing the map from the server computer; and
displaying, by the client device, the map showing the path of the journey and the supplemental information at the location on the path corresponding to location datum.

19. The method of claim 18, wherein the map request message further comprises journey identifying information.

20. The method of claim 19 wherein, the server computer determines the journey based on the journey identifying information, and obtains data associated with the journey from the database, wherein data for the journey includes location data, time data, and the supplemental information.

21. The method of claim 1, wherein the item is a food item.

22. The method of claim 21, wherein the first location includes a restaurant that makes the food item and the second location includes a dwelling where an end user that purchased the food item resides.
